(19) United States
(12) Patent Application Publication
(10) Pub. No.: US 2025/0344047 A1
(43) Pub. Date: Nov. 6, 2025

(54) Edge-Driven Network Provisioning

(71) Applicants: AT&T Intellectual Property I, L.P., Atlanta, GA (US); AT&T Mobility II LLC, Atlanta, GA (US)

(72) Inventors: Charles Diener, Atlanta, GA (US); Ricky Tsui, Daly City, CA (US); Roger Aboujaoude, Allen, TX (US); Limin Zhang, Marietta, GA (US); Atul Chadha, Frisco, TX (US); Sunil Thadani, Seattle, WA (US)

(73) Assignees: AT&T Intellectual Property I, L.P., Atlanta, GA (US); AT&T Mobility II LLC, Atlanta, GA (US)

(21) Appl. No.: 18/652,862

(22) Filed: May 2, 2024

(51) Int. Cl. H04W 4/50; H04W 24/02; H04W 48/18

(52) U.S. Cl. CPC H04W 4/50; H04W 24/02; H04W 48/18

(57) ABSTRACT

Edge-driven network provisioning can include receiving, from a customer premises equipment located at an installation site, a configuration request that identifies the customer premises equipment and a location associated with the installation site. Available connections can be identified for data communication services that are available at the installation site for the customer premises equipment. Provisioning options that are based on the available connections can be generated and a user device associated with the customer premises equipment can be identified. The provisioning options can be provided to the user device and the user device can present the provisioning options in a user interface presented at the user device. A provisioning selection corresponding to a selection of one of the provisioning options can be received and a provisioning command can be sent to one or more recipients to cause a service to be provisioned to the customer premises equipment.

### BACKGROUND

During a service ordering process, telecommunications services customers may specify exactly what type of service is being ordered and installed at a particular location. Thus, customers may choose a type of packet service, a speed or bandwidth for the service, and a hardware configuration that is desired for the particular location. This information may be passed to the service provider.

The specified service type, speed, hardware configuration, and/or other preferences may be input to a provisioning system and used to select a customer premises equipment that is to be installed at the customer location and/or provided to the customer for installation. When a customer needs or desires to change the type of packet service, the speed or bandwidth of the service, the hardware configuration, and/or other aspects of the service, changes may be needed to the customer premises equipment. Such changes may be inconvenient and/or inefficient but may be necessary.

### SUMMARY

The present disclosure is directed to edge-driven network provisioning. A user or other entity may order communication services for a location such as a home, office, business, or other installation site. Instead of being provided with a service-specific customer premises equipment that may be sent to a customer as part of the service ordering process, embodiments of the concepts and technologies disclosed herein can include sending a non-service-specific customer premises equipment to the user or other entity for installation at the installation site, thus enabling edge-driven provisioning of network services. The embodiments of the concepts and technologies disclosed herein can be used to enable the customer premises equipment upon and/or after installation at the installation site based on what services are available at the installation site. In particular, upon activating the customer premises equipment, the customer premises equipment can be configured (e.g., via execution of the provisioning module) to send a configuration request to the customer premises equipment management service, which can be hosted and/or executed by the server computer. As will be illustrated and described in more detail herein, the activation process can also include configuring and/or provisioning a network edge for services requested in conjunction with the customer premises equipment. It should be understood that this example embodiment is illustrative, and therefore should not be construed as being limiting in any way.

The configuration request can be received at a service provider system or device (e.g., a server computer) from the customer premises equipment via an out-of-band communication channel (e.g., a communication channel provided by a cellular connection or the like) and a service provider application programming interface (“API”) that can be exposed by a service provider device and/or system (e.g., the server computer). The configuration request can identify or assign an address (e.g., an Internet Protocol (“IP”) address, a geographic location such as a street address, and/or other location information) associated with the installation site and/or identifying information associated with the customer premises equipment. It should be understood that this example embodiment is illustrative, and therefore should not be construed as being limiting in any way.

The customer premises equipment management service can be configured to identify an entity associated with the customer premises equipment (e.g., a user or account) and one or more user devices (e.g., the user device) associated with the user or account. The customer premises equipment management service can identify the user or account and/or the user device via one or more queries. The customer premises equipment management service also can be configured to determine, via queries to various network elements such as a subscriber database, a network topology, and the like, one or more services that are available for the customer premises equipment at the installation site. The customer premises equipment management service can generate data representing the available services as provisioning options and send the provisioning options to (or directed to) the user device.

The user device can present the provisioning options in a user interface at the user device and a user or other entity can select one or more of the provisioning options. The user device can generate and send provisioning selections that represent the selected services to the customer premises equipment and a network device such as a provider edge for provisioning of the selected services. It therefore can be appreciated that embodiments of the concepts and technologies disclosed herein can enable selection and provisioning of services by edge devices such as the provider edge and the customer premises equipment as opposed to a centrally located provisioning device or resource. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include receiving a configuration request from a customer premises equipment located at an installation site. The configuration request can identify the customer premises equipment and a location associated with the installation site. The operations further can include identifying available connections, the available connections including two or more data communication services that are available at the installation site for the customer premises equipment; generating provisioning options that are based on the available connections; and identifying a user device associated with the customer premises equipment. The user device can be identified using information included in the configuration request. The operations further can include providing, to the user device, the provisioning options, where the user device can present the provisioning options in a user interface presented at the user device; receiving a provisioning selection including a selection of one of the provisioning options; and sending a provisioning command including computer-executable instructions to the customer premises equipment and a device on the network. The provisioning command, when executed by the customer premises equipment and the device on the network, can cause a service to be provisioned to the customer premises equipment. The service can correspond to the selection of one of the provisioning options.

In some embodiments, identifying the available connections can include determining a location associated with the customer premises equipment and determining the two or more data communication services that are available at the installation site. In some embodiments, the two or more data communication services can include a temporary wireless connection and a non-wireless connection. In some embodiments, the customer premises equipment can include first hardware for a fiber-based data connection and second hardware for a wireless data connection.

In some embodiments, the configuration request can be received from the customer premises equipment via an out-of-band communication channel and a service provider application programming interface. In some embodiments, identifying the user device can include identifying, via identifying information included in the configuration request, the user device by querying a subscriber database. In some embodiments, the device on the network can include a provider edge, and sending the provisioning command can include sending the provisioning command to the customer premises equipment and the provider edge to cause the customer premises equipment and the provider edge to communicate via a requested connection.

According to another aspect of the concepts and technologies disclosed herein, a method is disclosed. The method can include receiving, at a computer including a processor and from a customer premises equipment located at an installation site, a configuration request. The configuration request can identify the customer premises equipment and a location associated with the installation site. The method further can include identifying, by the processor, available connections, the available connections including two or more data communication services that are available at the installation site for the customer premises equipment; generating, by the processor, provisioning options that are based on the available connections; and identifying, by the processor, a user device associated with the customer premises equipment. The user device can be identified using information included in the configuration request. The method further can include providing, by the processor and to the user device, the provisioning options, where the user device can present the provisioning options in a user interface presented at the user device; receiving, by the processor, a provisioning selection including a selection of one of the provisioning options; and sending, by the processor, a provisioning command including computer-executable instructions to the customer premises equipment and a device on the network. The provisioning command, when executed by the customer premises equipment and the device on the network, can cause a service to be provisioned to the customer premises equipment. The service can correspond to the selection of one of the provisioning options.

In some embodiments, identifying the available connections can include determining a location associated with the customer premises equipment and determining the two or more data communication services that are available at the installation site. In some embodiments, the two or more data communication services can include a temporary wireless connection and a non-wireless connection. In some embodiments, the customer premises equipment can include first hardware for a fiber-based data connection and second hardware for a wireless data connection.

In some embodiments, the configuration request can be received from the customer premises equipment via an out-of-band communication channel and a service provider application programming interface. In some embodiments, identifying the user device can include identifying, via identifying information included in the configuration request, the user device by querying a subscriber database. In some embodiments, the device on the network can include a provider edge, and sending the provisioning command can include sending the provisioning command to the customer premises equipment and the provider edge to cause the customer premises equipment and the provider edge to communicate via a requested connection.

According to yet another aspect of the concepts and technologies disclosed herein, a computer storage medium is disclosed. The computer storage medium can store computer-executable instructions that, when executed by a processor, cause the processor to perform operations. The operations can include receiving, from a customer premises equipment located at an installation site, a configuration request. The configuration request can identify the customer premises equipment and a location associated with the installation site. The operations further can include identifying available connections, the available connections including two or more data communication services that are available at the installation site for the customer premises equipment; generating provisioning options that are based on the available connections; and identifying a user device associated with the customer premises equipment. The user device can be identified using information included in the configuration request. The operations further can include providing, to the user device, the provisioning options, where the user device can present the provisioning options in a user interface presented at the user device; receiving a provisioning selection including a selection of one of the provisioning options; and sending a provisioning command including computer-executable instructions to the customer premises equipment and a device on the network. The provisioning command, when executed by the customer premises equipment and the device on the network, can cause a service to be provisioned to the customer premises equipment. The service can correspond to the selection of one of the provisioning options.

In some embodiments, identifying the available connections can include determining a location associated with the customer premises equipment and determining the two or more data communication services that are available at the installation site. In some embodiments, the two or more data communication services can include a temporary wireless connection and a non-wireless connection. In some embodiments, the customer premises equipment can include first hardware for a fiber-based data connection and second hardware for a wireless data connection.

In some embodiments, the configuration request can be received from the customer premises equipment via an out-of-band communication channel and a service provider application programming interface. In some embodiments, identifying the user device can include identifying, via identifying information included in the configuration request, the user device by querying a subscriber database. In some embodiments, the device on the network can include a provider edge, and sending the provisioning command can include sending the provisioning command to the customer premises equipment and the provider edge to cause the customer premises equipment and the provider edge to communicate via a requested connection.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for a customer premises equipment establishing a connection with a provider edge, according to an illustrative embodiment of the concepts and technologies described herein.

FIG. 3 is a flow diagram showing aspects of a method for provisioning a customer premises equipment, according to an illustrative embodiment of the concepts and technologies described herein.

FIG. 4 is a flow diagram showing aspects of a method for selecting provisioning options for a customer premises equipment, according to an illustrative embodiment of the concepts and technologies described herein.

FIGS. 5A-5C are user interface diagrams showing various screen displays for providing edge-driven network provisioning, according to some illustrative embodiments of the concepts and technologies described herein.

FIG. 6 schematically illustrates a network, according to an illustrative embodiment of the concepts and technologies described herein.

FIG. 7 is a block diagram illustrating an example computer system configured to provide edge-driven network provisioning, according to some illustrative embodiments of the concepts and technologies described herein.

FIG. 8 is a block diagram illustrating an example mobile device configured to interact with a customer premises equipment management service, according to some illustrative embodiments of the concepts and technologies described herein.

FIG. 9 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to edge-driven network provisioning. A user or other entity may order communication services for a location such as a home, office, business, or other installation site. While some other network services can be provided by service-specific customer premises equipment that may be sent to a customer as part of the service ordering process, embodiments of the concepts and technologies disclosed herein can include sending a non-service-specific customer premises equipment to the user or other entity for installation at the installation site, thus enabling edge-driven provisioning of network services. The embodiments of the concepts and technologies disclosed herein can be used to enable the customer premises equipment upon and/or after installation at the installation site based on what services are available at the installation site. In particular, upon activating the customer premises equipment, the customer premises equipment can be configured (e.g., via execution of the provisioning module), to send a configuration request to the customer premises equipment management service, which can be hosted and/or executed by the server computer.

The configuration request can be received at the server computer from the customer premises equipment via an out-of-band communication channel and a service provider API that can be exposed by the server computer. The configuration request can identify an address (e.g., an IP address, a geographic location such as a street address, and/or other location information) associated with the installation site and/or identifying information associated with the customer premises equipment. It should be understood that this example embodiment is illustrative, and therefore should not be construed as being limiting in any way.

The customer premises equipment management service can be configured to identify an entity associated with the customer premises equipment (e.g., a user or account) and one or more user devices (e.g., the user device) associated with the user or account. The customer premises equipment management service can identify the user or account and/or the user device via one or more queries. The customer premises equipment management service also can be configured to determine, via queries to various network elements such as a subscriber database, a network topology, and the like, one or more services that are available for the customer premises equipment at the installation site. The customer premises equipment management service can generate data representing the available services as provisioning options and send the provisioning options to (or directed to) the user device.

The user device can present the provisioning options in a user interface at the user device and a user or other entity can select one or more of the provisioning options. The user device can generate and send provisioning selections that represent the selected services to the customer premises equipment and a network device such as a provider edge for provisioning of the selected services. It therefore can be appreciated that embodiments of the concepts and technologies disclosed herein can enable selection and provisioning of services by edge devices such as the provider edge and the customer premises equipment as opposed to a centrally located provisioning device or resource. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

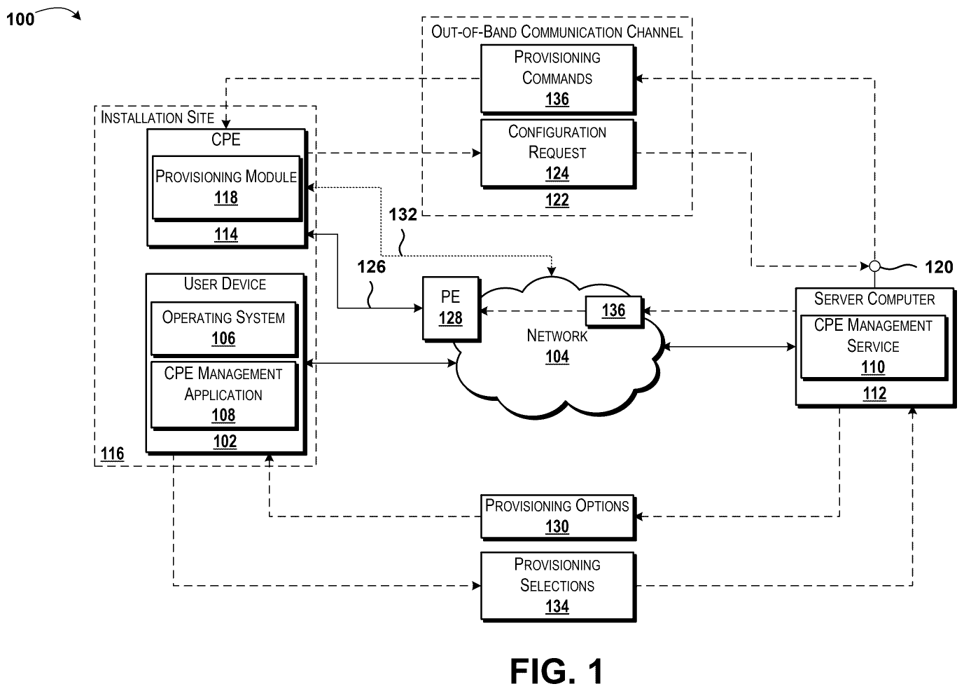

Referring now to FIG. 1, aspects of an operating environment 100 for various embodiments of the concepts and technologies disclosed herein for edge-driven network provisioning will be described, according to an illustrative embodiment. The operating environment 100 shown in FIG. 1 includes a user device 102. The user device 102 can operate in communication with and/or as part of a communications network (“network”) 104, though this is not necessarily the case.

According to various embodiments, the functionality of the user device 102 may be provided by one or more server computers, desktop computers, mobile telephones, laptop computers, set-top boxes, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can execute an operating system 106 and one or more application programs such as, for example, a customer premises equipment management application 108 (labeled “CPE management application 108 in FIG. 1”). The operating system 106 can include a computer program that can control the operation of the user device 102. The customer premises equipment management application 108 can include an executable program that can be configured to execute on top of the operating system 106 to provide various functions as illustrated and described herein for providing edge-driven network provisioning. The functionality of the customer premises equipment management application 108 will be explained in more detail after first introducing the other components of the operating environment 100.

As shown in FIG. 1, the operating environment 100 also can include a customer premises equipment management service 110 (labeled “CPE management service 110” in FIG. 1), which can be hosted and/or executed by a device such as the server computer 112. According to various embodiments of the concepts and technologies disclosed herein, the functionality of the server computer 112 may be provided by one or more server computers, application servers, web servers, data processing resources, gateway devices, routers, other computing systems, and the like. It should be understood that the functionality of the server computer 112 may be provided by a single device, by two or more similar devices, and/or by two or more dissimilar devices. For purposes of describing the concepts and technologies disclosed herein, the server computer 112 is described herein as an application server. It should be understood that this embodiment is illustrative, and should not be construed as being limiting in any way.

The operating environment 100 also can include a customer premises equipment 114 (labeled “CPE” in FIG. 1). The customer premises equipment 114 can be located in an installation site 116 such as a home, an office, a business, or other building, structure, or area. According to various embodiments of the concepts and technologies disclosed herein, the customer premises equipment 114 can be located (at least at some point in time) in the same installation site at which the user device 102 may be contemporaneously located, for example, during an activation and/or provisioning operation. It should be understood that this example embodiment is illustrative, and therefore should not be construed as being limiting in any way.

According to various embodiments of the concepts and technologies disclosed herein, the customer premises equipment 114 can include a provisioning module 118 and/or other software application, module, or the like. The provisioning module 118 can be configured to request and/or obtain configuration and/or provisioning from a service provider (e.g., a service provider associated with the server computer 112). The functions of the provisioning module 118 will be described in detail with the functionality of the customer premises equipment management application 108.

According to various embodiments of the concepts and technologies disclosed herein, the customer premises equipment management application 108 can be configured to interact with the customer premises equipment management service 110 to configure and/or provision a customer premises equipment 114 that has been brought to and/or installed at the installation site 116. It can be appreciated that in various embodiments of the concepts and technologies disclosed herein, the customer premises equipment 114 may be shipped by a service provider (e.g., a service provider associated with the server computer 112 and/or the customer premises equipment management service 110) to a customer or other entity at the installation site 116 for activation and/or installation. The customer premises equipment management application 108 can be configured to communicate with the service provider (e.g., with the server computer 112 and/or the customer premises equipment management service 110) to configure and/or provision the customer premises equipment 114. It should be understood that this example embodiment is illustrative, and therefore should not be construed as being limiting in any way.

According to various embodiments, the customer premises equipment 114 also can execute the provisioning module 118 as part of the configuration and/or provisioning process. In particular, the provisioning module 118 can be configured to detect the activation (e.g., powering-on, startup, etc.) of the customer premises equipment 114, which may be understood as indicating that the customer premises equipment 114 has been installed at the installation site 116. It should be understood that this example embodiment is illustrative, and therefore should not be construed as being limiting in any way.

Upon detecting the activation of the customer premises equipment 114, the provisioning module 118 can be configured to establish communications with the customer premises equipment management service 110. According to various embodiments of the concepts and technologies disclosed herein, the server computer 112 can expose a service provider API 120 via which the customer premises equipment 114 can connect to the customer premises equipment management service 110, and the provisioning module 118 can be configured to establish an out-of-band communication channel 122 with the customer premises equipment management service 110 via the service provider API 120. It should be understood that this example embodiment is illustrative, and therefore should not be construed as being limiting in any way.

According to various embodiments of the concepts and technologies disclosed herein, the customer premises equipment 114 can include hardware for supporting multiple communication technologies such as, for example, wireless communications, DSL communications, fiber-based communications, and/or other types of communications. Thus, it should be understood that the customer premises equipment 114 can include a wireless transceiver and identification modules such as a subscriber identity module (“SIM”), a universal integrated circuit card (“UICC”), and/or other identity modules or functionality for negotiating connections with wireless and/or wired connections and/or networks. It should be understood that this example embodiment is illustrative, and therefore should not be construed as being limiting in any way.

The out-of-band communication channel 122 can correspond to a communication channel that can be established by the customer premises equipment 114 when first powered up (e.g., before the customer premises equipment 114 has been provisioned with services). In some embodiments of the concepts and technologies disclosed herein, the out-of-band communication channel 122 can be provided by a wireless connection between the customer premises equipment 114 and the server computer 112; by a WiFi connection (e.g., between the customer premises equipment 114 and the user device 102 and/or other devices at the installation site 116), and/or other network connections. The term “out-of-band” is used to exclude the network connection that the customer premises equipment 114 is meant to provide (e.g., a fiber connection, or the like). It should be understood that this example embodiment is illustrative, and therefore should not be construed as being limiting in any way.

In addition to establishing the out-of-band communication channel 122 between the customer premises equipment 114 and the server computer 112, the provisioning module 118 can be configured to generate a configuration request 124. The configuration request 124 can request provisioning of a requested connection 126 (e.g., a requested Internet connection) between the customer premises equipment 114 and a component of the network 104 such as, for example, a provider edge 128. By way of example, the requested connection 126 can correspond to a fiber connection between the customer premises equipment 114 and the provider edge 128. It should be understood that this example embodiment is illustrative, and therefore should not be construed as being limiting in any way.

The configuration request 124 can include a request to configure and/or provision the customer premises equipment 114 with services. When generating the configuration request, the customer premises equipment 114 can be configured (e.g., via execution of the provisioning module 118) to include a customer premises equipment identifier (e.g., a unique identifier that can identify this customer premises equipment 114 uniquely). In some embodiments, the customer premises equipment 114 can also be configured to determine its address (e.g., a street address associated with the installation site 116, an IP address associated with customer premises equipment 114, a media access control (“MAC”) address associated with the customer premises equipment 114, and/or other forms of identifiers) and include the address in the configuration request 124 as an identifier and/or as a form of verification information. It should be understood that in some embodiments of the concepts and technologies disclosed herein, the customer premises equipment 114 can be configured to assign its address during startup and therefore can “identify” its address via assigning that address. It should be understood that this example embodiment is illustrative, and therefore should not be construed as being limiting in any way.

In some embodiments, the customer premises equipment 114 can also be configured to provide authentication information with the configuration request 124 such as an email address, phone number, password, and/or other information for purposes of authenticating the customer premises equipment 114 with the customer premises equipment management service 110. It should be understood that this example embodiment is illustrative, and therefore should not be construed as being limiting in any way.

According to various embodiments of the concepts and technologies disclosed herein, the customer premises equipment 114 can be configured to send the configuration request 124 to and/or directed to the customer premises equipment management service 110 via the out-of-band communication channel 122 (and via the service provider API 120). Thus, the customer premises equipment 114 can be configured (by execution of the provisioning module 118) to request configuration and/or provisioning of the customer premises equipment 114 when powered-on. Embodiments of the concepts and technologies disclosed herein can therefore enable the shipping of a standard customer premises equipment 114 to customers (whereas previous approaches include the sending of a service-specific customer premises equipment 114 to customers) and allowing the customers and/or others to provision the customer premises equipment 114 based on what services are available at the installation site 116. These and other aspects of the concepts and technologies disclosed herein will be more fully explained herein.

The customer premises equipment management service 110 can be configured to recognize receipt of the configuration request 124. The customer premises equipment management service 110 can analyze the configuration request 124 and determine, based on the data included in the configuration request 124, a customer associated with the customer premises equipment 114 (e.g., based on the identifier, authentication information, address, and/or other information included in the configuration request 124). The customer premises equipment management service 110 can access one or more other devices (not shown in FIG. 1) such as a subscriber database, a customer database, or the like to identify the customer (or other entity) and a device associated with the customer or other entity. In the illustrated embodiment of FIG. 1, the user device 102 is a device used by the customer or other entity associated with the installation site 116. It should be understood that this example embodiment is illustrative, and therefore should not be construed as being limiting in any way.

Based on the identity of the customer premises equipment 114, the user, and/or the user device 102, the customer premises equipment management service 110 can determine the actual physical location of the customer premises equipment 114 (e.g., a street address, GPS coordinates, or the like). Based on this information, the customer premises equipment management service 110 can query one or more other devices or resources (e.g., a network topology data structure, a network device or resource, or the like) to determine what services are available at the installation site. For example, the customer premises equipment management service 110 can determine if fiber is available at the installation site 116, if wireless is available at the installation site 116, if other types of connections are available at the installation site 116, and/or the like.

The customer premises equipment management service 110 can identify the user and/or a device associated with the user (e.g., the user device 102) and send, directed to the user device 102, one or more provisioning options 130 comprising service options available at the installation site 116. Thus, for example, the provisioning options 130 can include one or more connection technologies that exist at the installation site 116, costs for provisioning and using one or more services using the connection technologies, combinations thereof, or the like. These provisioning options 130 can be generated by the customer premises equipment management service 110 and can be provided as a table or other data structure. In some embodiments, the customer premises equipment management service 110 can include, as one of the provisioning options 130, an option to activate a temporary wireless connection 132 between the customer premises equipment 114 and the network 104 (or a component thereof) while the requested connection 126 is being provisioned. It should be understood that this example embodiment is illustrative, and therefore should not be construed as being limiting in any way.

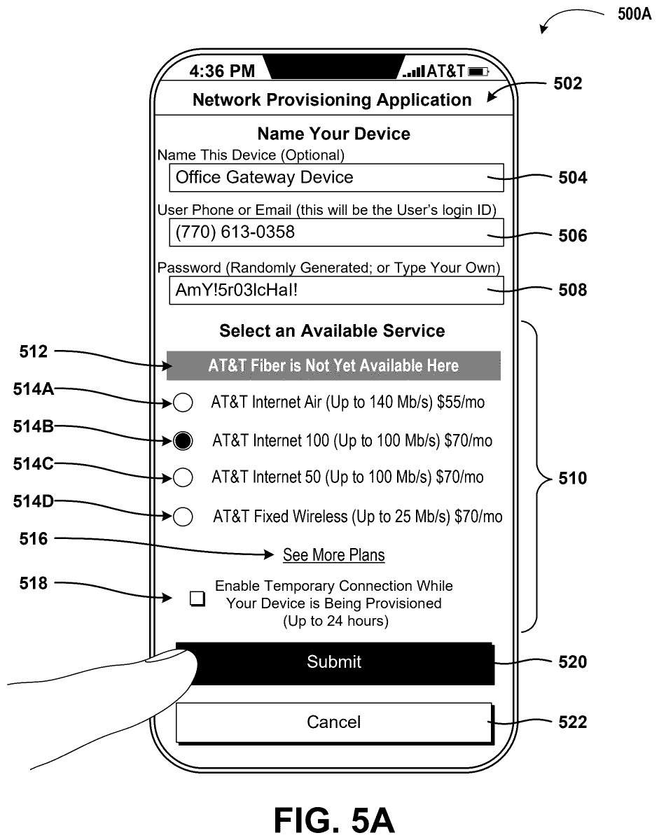

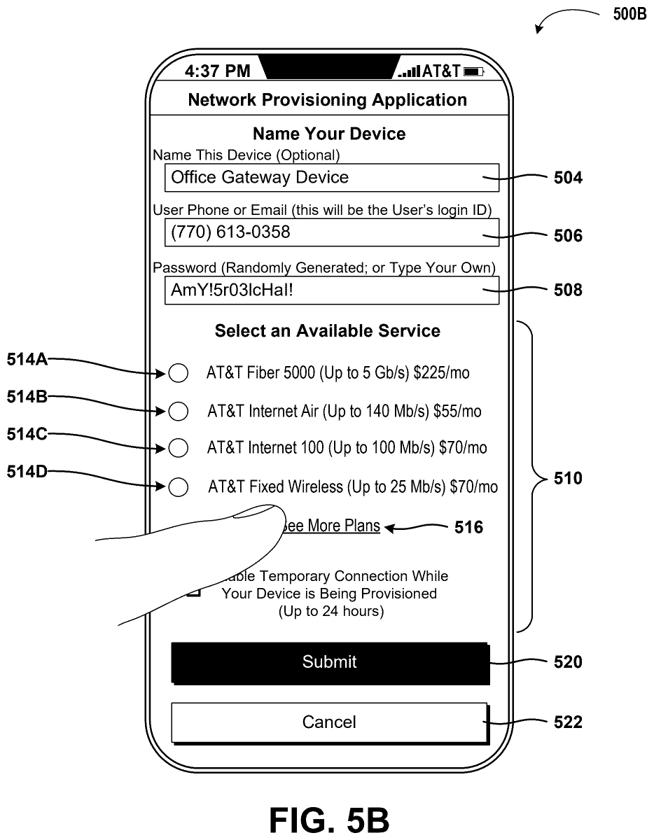

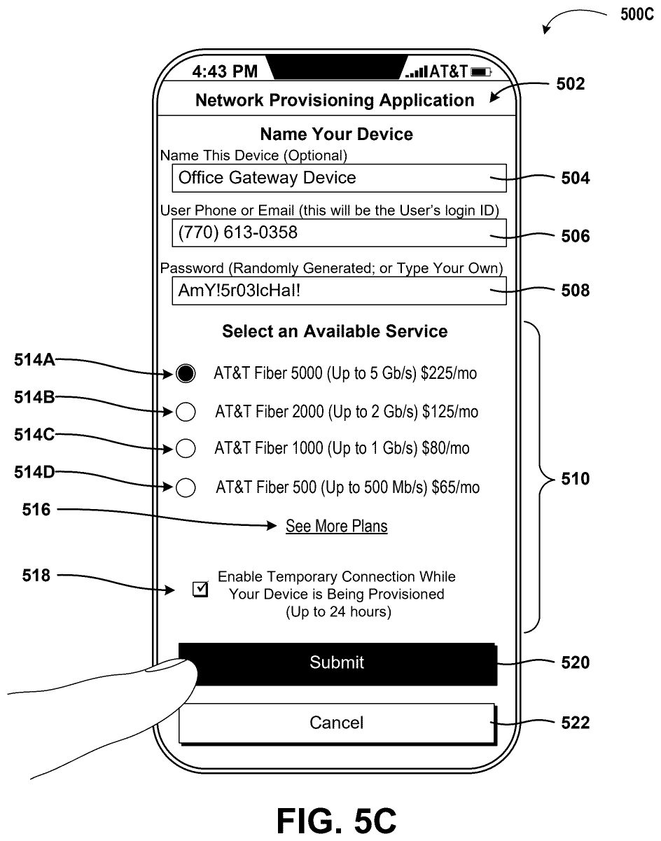

The user device 102 can receive the provisioning options 130 from the customer premises equipment management service 110. The customer premises equipment management application 108 can be configured to generate a user interface for presenting the options included in the provisioning options 130 and obtaining, from a user or other entity, one or more selections of the options for provisioning. By way of example, the provisioning options 130 can include a first option to provision a fiber connection, a second option to provision a wireless connection, a third option to provision a digital subscriber line (“DSL”) connection, other options, or the like. The user or other entity can select one or more of these options via the user interface and the customer premises equipment management application 108 can generate data representing the selections as the provisioning selections 134. Some example user interfaces for presenting the provisioning options 130 and obtaining provisioning selections 134 will be illustrated and described hereinbelow with reference to FIGS. 5A-5C. It should be understood that this example embodiment is illustrative, and therefore should not be construed as being limiting in any way.

The user device 102 can be configured (e.g., via execution of the customer premises equipment management application 108) to send the provisioning selections 134 to the server computer 112. The customer premises equipment management service 110 can receive the provisioning selections 134 from the user device 102 and determine what one or more than one service is to be provisioned. By way of example, a user or other entity may indicate that a fiber connection is requested along with a temporary wireless connection, and the provisioning selections 134 can indicate this. Thus, the customer premises equipment management service 110 can determine that these two services (i.e., a fiber connection and a temporary wireless connection) should be provisioned. It should be understood that this example embodiment is illustrative, and therefore should not be construed as being limiting in any way.

Based on the determined provisioning, the customer premises equipment management service 110 can generate one or more provisioning commands 136. The provisioning commands 136 can include executable instructions that, when received and executed by a device, cause the device to communicate to complete provisioning with a network element and/or technology such as the requested connection 126 with the provider edge 128. It should be understood that this example embodiment is illustrative, and therefore should not be construed as being limiting in any way.

The customer premises equipment management service 110 can output the provisioning commands 136 to the customer premises equipment 114 via the service provider API 120 and the out-of-band communication channel 122 as shown in FIG. 1. The customer premises equipment management service 110 also can be configured to send the provisioning commands 136 to one or more elements of the network 104 such as, for example, the provider edge 128. The provider edge 128 and the customer premises equipment 114 can communicate with one another to provision the requested services. In some embodiments of the concepts and technologies disclosed herein, it can be appreciated that the customer premises equipment management service 110 can send provisioning commands 136 to multiple entities (e.g., the customer premises equipment 114, the provider edge 128, and/or other entities). For example, the provisioning commands 136 can instruct the customer premises equipment 114 to establish the temporary wireless connection 132 with the network 104 (or component thereof) and to provision the requested connection 126. It should be understood that this example embodiment is illustrative, and therefore should not be construed as being limiting in any way.

Thus, it can be appreciated that the customer premises equipment 114 can be shipped to or otherwise located at the installation site 116 with the ability to connect to multiple networking connections and/or to use multiple technologies. Embodiments of the concepts and technologies disclosed herein enable a user or other entity to trigger determination of what connections and/or services are available at the installation site 116 and then to provision and/or configure the customer premises equipment 114. In some embodiments of the concepts and technologies disclosed herein, this approach can avoid shipping a customer premises equipment 114 to a user and then, in response to determining that a requested connection 126 is not available at the installation site 116, being required to ship a new customer premises equipment 114 to the installation site. It should be understood that this example embodiment is illustrative, and therefore should not be construed as being limiting in any way.

In practice, a user or other entity may order communication services for a location such as a home, office, business, or other installation site 116. While other technologies can include sending a service-specific customer premises equipment to a customer, embodiments of the concepts and technologies disclosed herein can include sending a non-service-specific customer premises equipment 114 to the user or other entity for installation at the installation site 116. The embodiments of the concepts and technologies disclosed herein can be used to enable the customer premises equipment 114 upon and/or after installation at the installation site 116 based on what services are available at the installation site 116. In particular, upon activating the customer premises equipment 114, the customer premises equipment 114 can be configured (e.g., via execution of the provisioning module 118), to send a configuration request 124 to the customer premises equipment management service 110, which can be hosted and/or executed by the server computer 112.

The configuration request 124 can be received at the server computer 112 from the customer premises equipment 114 via an out-of-band communication channel 122 and a service provider API 120 that can be exposed by the server computer 112. The configuration request can assign and/or identify an address (e.g., an IP address, a geographic location such as a street address, and/or other location information) associated with the installation site and/or identifying information associated with the customer premises equipment 114. It should be understood that this example embodiment is illustrative, and therefore should not be construed as being limiting in any way.

The customer premises equipment management service 110 can be configured to identify an entity associated with the customer premises equipment 114 (e.g., a user or account) and one or more user devices (e.g., the user device 102) associated with the user or account. The customer premises equipment management service 110 can identify the user or account and/or the user device 102 via one or more queries. The customer premises equipment management service 110 also can be configured to determine, via queries to various network elements such as a subscriber database, a network topology, and the like, one or more services that are available for the customer premises equipment 114 at the installation site 116. The customer premises equipment management service 110 can generate data representing the available services as provisioning options 130 and send the provisioning options 130 to (or directed to) the user device 102.

The user device 102 can present the provisioning options 130 in a user interface at the user device 102 and a user or other entity can select one or more of the provisioning options 130. The user device 102 can generate and send provisioning selections 134 that represent the selected services to the customer premises equipment 114 and a network device such as a provider edge 128 for provisioning of the selected services. It therefore can be appreciated that embodiments of the concepts and technologies disclosed herein can enable selection and provisioning of services by edge devices such as the provider edge 128 and the customer premises equipment 114 as opposed to a centrally located provisioning device or resource. It should be understood that this example embodiment is illustrative, and therefore should not be construed as being limiting in any way.

FIG. 1 illustrates one user device 102, one network 104, one server computer 112, one customer premises equipment 114, and one provider edge 128. It should be understood, however, that various implementations of the operating environment 100 can include one or more than one user device 102; one or more than one network 104; zero, one, or more than one server computer 112; one or more than one customer premises equipment 114; and/or one or more than one provider edge 128. As such, the illustrated embodiment should be understood as being illustrative, and should not be construed as being limiting in any way.

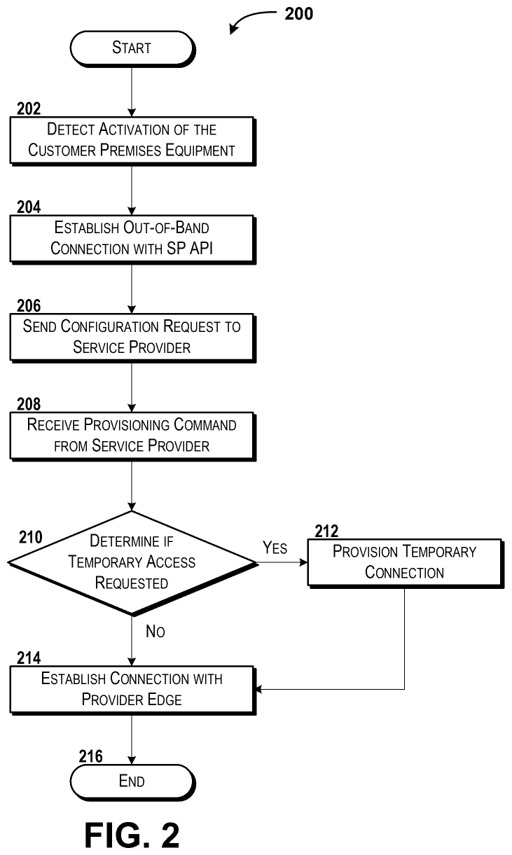

Turning now to FIG. 2, aspects of a method 200 for a customer premises equipment establishing a connection with a provider edge will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102, the server computer 112, and/or the customer premises equipment 114, to perform one or more operations and/or causing the processor to direct other components of the computing system or device to perform one or more of the operations.

For purposes of illustrating and describing the concepts of the present disclosure, the method 200 is described herein as being performed by the customer premises equipment 114 via execution of one or more software modules such as, for example, the provisioning module 118. It should be understood that additional and/or alternative devices and/or network nodes can provide the functionality described herein via execution of one or more modules, applications, and/or other software including, but not limited to, the provisioning module 118. Thus, the illustrated embodiments are illustrative, and should not be viewed as being limiting in any way.

The method 200 begins at operation 202. At operation 202, the customer premises equipment 114 can detect activation of the customer premises equipment 114. Thus, in operation 202 the customer premises equipment 114 may determine that the customer premises equipment 114 has been powered-on, started up, booted, or the like. In some embodiments, the customer premises equipment 114 can include a hardware button for a setup process and operation 202 can correspond to the customer premises equipment determining that the hardware button has been pressed. In other embodiments, the customer premises equipment 114 can be given commands to begin the method 200 via a software control (e.g., the provisioning module 118) without detecting the activation of the customer premises equipment 114. As such, the illustrated embodiment of FIG. 2 is illustrative and should not be construed as being limiting in any way.

From operation 202, the method 200 can proceed to operation 204. At operation 204, the customer premises equipment 114 can establish an out-of-band communication channel 122 with a service provider API 120 or other service provider device. In some embodiments of the concepts and technologies disclosed herein, the customer premises equipment 114 can communicate with the server computer 112 wirelessly and establish the out-of-band communication channel 122 wirelessly. It should be understood that this example embodiment is illustrative, and therefore should not be construed as being limiting in any way.

From operation 204, the method 200 can proceed to operation 206. At operation 206, the customer premises equipment 114 can generate and send a configuration request 124 to the service provider (e.g., to a device associated with the service provider such as the server computer 112). It can be appreciated with reference to FIG. 1 that the configuration request 124 can be sent to the server computer 112 via the out-of-band communication channel 122 and the service provider API 120. It should be understood that this example embodiment is illustrative, and therefore should not be construed as being limiting in any way.

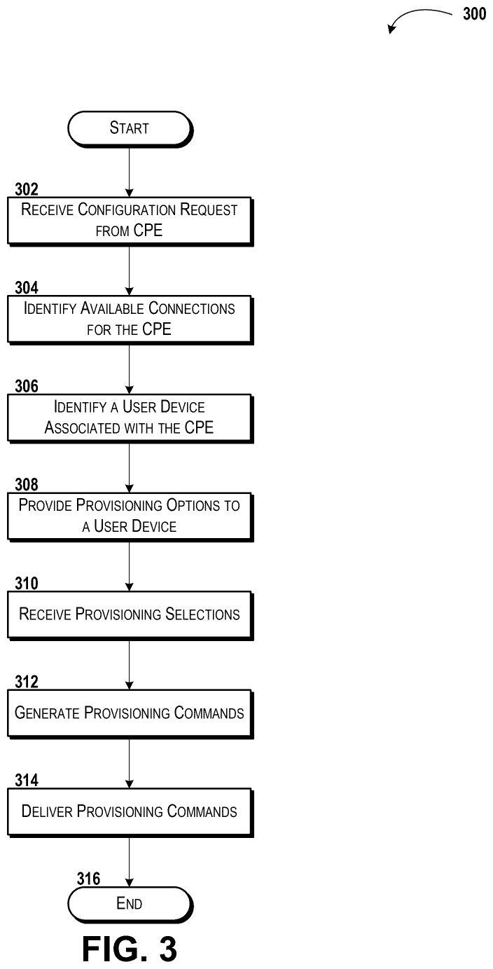

As will be illustrated and described below with reference to FIG. 3, the server computer 112 can be configured to determine what services are available at the installation site 116 and to communicate with other entities to determine that services should be provisioned for the customer premises equipment 114. The server computer 112 can then generate and send one or more provisioning commands 136 to the customer premises equipment 114 and/or other entities to begin provisioning. It should be understood that this example embodiment is illustrative, and therefore should not be construed as being limiting in any way.

From operation 206, the method 200 can proceed to operation 208. At operation 208, the customer premises equipment 114 can receive, from the service provider (e.g., the server computer 112), one or more provisioning commands 136. As explained above, the provisioning commands 136 can include computer-executable instructions and/or other forms of data that, when received by the customer premises equipment 114, can be executed to cause the customer premises equipment 114 to communicate with one or more other entities (e.g., the provider edge 128 and/or other components of the network 104) to establish communications and/or to complete provisioning. It should be understood that the service provider (e.g., the server computer 112 or other entities) can also forward the provisioning commands 136 to other entities (e.g., the provider edge 128 and/or other components of the network 104 and/or other networks) to complete the provisioning. It should be understood that this example embodiment is illustrative, and therefore should not be construed as being limiting in any way.

From operation 208, the method 200 can proceed to operation 210. At operation 210, the customer premises equipment 114 can determine if temporary access has been requested. According to various embodiments of the concepts and technologies disclosed herein, the user or other entity can select and/or configure (e.g., via a user interface provided at the user device 102, via configurations and/or settings, or the like) an option to establish a temporary connection (e.g., the temporary wireless connection 132) between the customer premises equipment 114 and one or more entities on the network 104 when requesting provisioning. Thus, it can be appreciated that the customer premises equipment 114 can have an established temporary link for communications before and/or during provisioning of the requested connection 126. It should be understood that this example embodiment is illustrative, and therefore should not be construed as being limiting in any way.

If the customer premises equipment 114 determines, in operation 210, that temporary access has been requested, the method 200 can proceed to operation 212. At operation 212, the customer premises equipment 114 can provision the temporary connection (e.g., the temporary wireless connection 132 shown in FIG. 1 and/or other temporary connections). In some embodiments of the concepts and technologies disclosed herein, the customer premises equipment 114 can activate a wireless transceiver and attach to a wireless network via authentication (e.g., using subscriber information stored in a security module such as a SIM, a UICC, or the like). The customer premises equipment 114 can attach to a wireless network (for example) and use a data connection provided by the wireless network. It should be understood that this example embodiment is illustrative, and therefore should not be construed as being limiting in any way.

If the customer premises equipment 114 determines, in operation 210, that temporary access has not been requested, the method 200 can proceed to operation 214. The method 200 also can proceed to operation 214 from operation 212. At operation 214, the customer premises equipment 114 can provision the requested connection 126 (e.g., a connection with the provider edge 128). According to various embodiments of the concepts and technologies disclosed herein, the customer premises equipment 114 can negotiate the connection with the provider edge 128 according to various methodologies, which generally are understood and therefore are not described in detail herein. If the customer premises equipment 114 had established a temporary wireless connection 132 in operation 212, it should be understood that the customer premises equipment 114 can tear down and/or otherwise stop using the temporary wireless connection 132 and move communications to the requested connection 126 as part of the functionality of operation 214. In some other embodiments, the customer premises equipment 114 can be configured to maintain the temporary wireless connection 132 as a backup connection for some period of time and/or indefinitely even after the requested connection 126 is established and communications via the requested connection 126 have been enabled and/or provisioned. It should be understood that this example embodiment is illustrative, and therefore should not be construed as being limiting in any way.

From operation 214, the method 200 can proceed to operation 216. The method 200 can end at operation 216.

Turning now to FIG. 3, aspects of a method 300 for provisioning a customer premises equipment will be described in detail, according to an illustrative embodiment. For purposes of illustrating and describing the concepts of the present disclosure, the method 300 is described herein as being performed by the server computer 112 via execution of one or more software modules such as, for example, the customer premises equipment management service 110. It should be understood that additional and/or alternative devices and/or network nodes can provide the functionality described herein via execution of one or more modules, applications, and/or other software including, but not limited to, the customer premises equipment management service 110. Thus, the illustrated embodiments are illustrative, and should not be viewed as being limiting in any way.

The method 300 begins at operation 302. At operation 302, the server computer 112 can receive a configuration request 124 from a customer premises equipment 114. According to various embodiments of the concepts and technologies disclosed herein, and as illustrated and described above with reference to FIG. 1, the configuration request 124 can be received at the server computer 112 via the service provider API 120 and can be sent to the server computer 112 by the customer premises equipment 114 and via an out-of-band communication channel 122. The configuration request 124 can identify the customer premises equipment 114, an address associated with the installation site 116 and/or the customer premises equipment 114, and/or other identifying information such as authentication information associated with the customer premises equipment 114 and/or a user or user device 102, user identity information, combinations thereof, or the like.

The configuration request 124 can request establishment and/or provisioning of communications for the customer premises equipment 114. According to various embodiments of the concepts and technologies disclosed herein, the customer premises equipment 114 may be shipped to a customer, user, or other entity (e.g., at the installation site 116) with hardware that can support various services (e.g., wireless communications, fiber-based communications, DSL communications, T1 communications, and/or other forms of communications). Thus, the configuration request 124 can effectively request identification of communications channels available to the customer premises equipment 114 and a determination of which channel is to be used for the customer premises equipment 114 (e.g., based on a user selection or the like). Thus, it can be appreciated that the server computer 112 can receive the configuration request 124 can determine available communication channels, user selections, and the like before provisioning communications. Because the configuration request 124 can explicitly request certain types of communications and/or connections (e.g., the requested connection 126, the temporary wireless connection 132, combinations thereof, or the like), it should be understood that this example embodiment is illustrative, and therefore should not be construed as being limiting in any way.

From operation 302, the method 300 can proceed to operation 304. At operation 304, the server computer 112 can identify available services and/or connections for the customer premises equipment 114. According to various embodiments of the concepts and technologies disclosed herein, the server computer 112 can be configured to query various network entities (e.g., a network topology or the like) to determine what capabilities exist at the installation site 116 and/or other locations at which the customer premises equipment 114 is located. Additionally, or alternatively, the server computer 112 can be configured to identify a user or other entity associated with the customer premises equipment 114 and send a query to the user device 102 to determine what capabilities exist at the installation site 116. Because the capabilities can be determined in additional and/or alternative manners (e.g., the customer premises equipment 114 can enter a discovery mode or the like to identify potential communications at the installation site 116 or elsewhere), it should be understood that these example embodiments are illustrative, and therefore should not be construed as being limiting in any way.

From operation 304, the method 300 can proceed to operation 306. At operation 306, the server computer 112 can identify a user device 102 associated with the customer premises equipment 114. According to various embodiments of the concepts and technologies disclosed herein, the configuration request 124 can include an address associated with the customer premises equipment 114 (e.g., an IP address, a physical address, or the like), and the server computer 112 can identify one or more accounts or account holders associated with the address (and/or query other entities (e.g., a subscriber database or the like) to determine the accounts or account holders associated with the address). Based on account information, identity information, an order number, or the like, the server computer 112 can identify one or more users associated with the customer premises equipment 114. The server computer 112 can then search subscriber and/or device databases to identify any other network-capable devices that are associated with the user or other entity. In the example shown in FIG. 3, the server computer 112 can identify the user device 102 as being associated with a user or customer who is also associated with the customer premises equipment 114. It should be understood that this example embodiment is illustrative, and therefore should not be construed as being limiting in any way.

From operation 306, the method 300 can proceed to operation 308. At operation 308, the server computer 112 can provide one or more provisioning options 130 to the user device 102 identified in operation 306. Thus, it can be appreciated that in operation 308, the server computer 112 can provide provisioning options 130 that represent the available connections identified in operation 304 to the user device 102 identified in operation 306. As such, it should be understood that the operation 308 can include the server computer 112 generating the provisioning options 130 (e.g., generating a data file that represents one or more connections that can be provisioned, or the like) as well as sending the provisioning options 130 to or directed to the user device 102. Although not illustrated in FIG. 3, the user device 102 can present the provisioning options 130 in a user interface to one or more users for review and/or selections. It should be understood that this example embodiment is illustrative, and therefore should not be construed as being limiting in any way.

From operation 308, the method 300 can proceed to operation 310. At operation 310, the server computer 112 can receive, from the user device 102, one or more provisioning selections 134. The provisioning selections 134 can indicate what connections the user or other entity associated with the user device 102 wants to use for communications. For example, the provisioning selections 134 can indicate that the user device 102 wants to establish a fiber-based Internet connection for the customer premises equipment 114 as the requested connection 126 as well as a temporary wireless connection 132. It should therefore be understood that operation 310 can include the server computer 112 receiving data that selects one or more network connections to be provisioned for the customer premises equipment 114. It should be understood that this example embodiment is illustrative, and therefore should not be construed as being limiting in any way.

From operation 310, the method 300 can proceed to operation 312. At operation 312, the server computer 112 can generate one or more provisioning commands 136. As noted above, the provisioning commands 136 can include computer-executable instructions and/or other forms of data that, when received by the customer premises equipment 114 and/or other entities such as the network 104 and/or the provider edge 128, can be executed to cause the customer premises equipment 114 or other entities to communicate to establish communications and/or to complete provisioning. It should be understood that the service provider (e.g., the server computer 112 or other entities) can also forward the provisioning commands 136 to other entities (e.g., the provider edge 128 and/or other components of the network 104 and/or other networks) to complete the provisioning. It should be understood that this example embodiment is illustrative, and therefore should not be construed as being limiting in any way.

From operation 312, the method 300 can proceed to operation 314. At operation 314, the server computer 112 can deliver the one or more provisioning commands 136 to one or more recipients. From the description of operation 312, it can be appreciated that the provisioning commands 136 can be sent to the customer premises equipment 114, the user device 102, the provider edge 128, the network 104, and/or other devices and/or entities. It should be understood that this example embodiment is illustrative, and therefore should not be construed as being limiting in any way.

From operation 314, the method 300 can proceed to operation 316. The method 300 can end at operation 316.

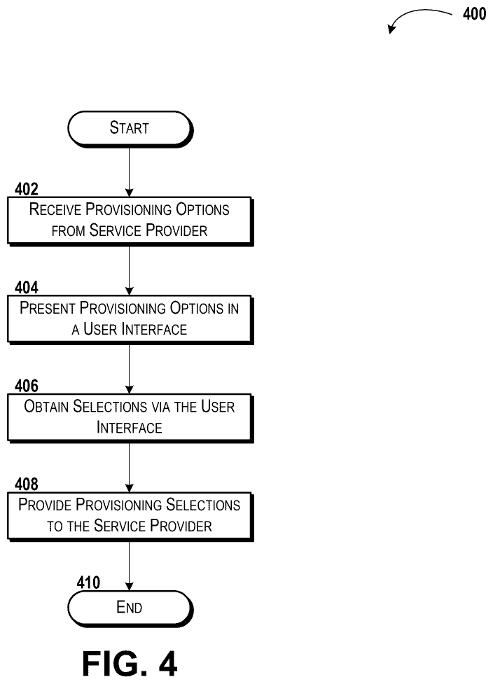

Turning now to FIG. 4, aspects of a method 400 for selecting provisioning options for a customer premises equipment will be described in detail, according to an illustrative embodiment. For purposes of illustrating and describing the concepts of the present disclosure, the method 400 is described herein as being performed by the user device 102 via execution of one or more software modules such as, for example, the customer premises equipment management application 108. It should be understood that additional and/or alternative devices and/or network nodes can provide the functionality described herein via execution of one or more modules, applications, and/or other software including, but not limited to, the customer premises equipment management application 108. Thus, the illustrated embodiments are illustrative, and should not be viewed as being limiting in any way.

The method 400 begins at operation 402. At operation 402, the user device 102 can receive provisioning options 130 from the service provider (e.g., from the customer premises equipment management service 110 hosted and/or executed by the server computer 112). As explained above, the provisioning options 130 can represent one or more connections that are available to the customer premises equipment 114. For example, the provisioning options 130 can include an option to provision a wireless connection, an option to provision a DSL connection, an option to provision a fiber-based internet connection, an option to provision a temporary wireless connection, and/or options to provision other types of connections and/or services.

From operation 402, the method 400 can proceed to operation 404. At operation 404, the user device 102 can present the provisioning options 130 in a user interface at the user device 102. Some example user interfaces for providing the provisioning options 130 will be illustrated and described below with reference to FIGS. 5A-5C. In general, however, it can be appreciated that the user interfaces can provide the one or more provisioning options 130 with one or more user interface controls for selecting one or more of the provisioning options 130 in operation 404. It should be understood that this example embodiment is illustrative, and therefore should not be construed as being limiting in any way.

From operation 404, the method 400 can proceed to operation 406. At operation 406, the user device 102 can obtain selections of the provisioning options 130 via the user interface. Some example user interfaces for obtaining the selections (of one or more of the provisioning options 130) will be illustrated and described below with reference to FIGS. 5A-5C. In general, however, it can be appreciated that the user device 102 can detect selections of one or more provisioning options 130 in operation 406. It should be understood that this example embodiment is illustrative, and therefore should not be construed as being limiting in any way.

From operation 406, the method 400 can proceed to operation 408. At operation 408, the user device 102 can provide provisioning selections 134 to the service provider (e.g., to the customer premises equipment management service 110 hosted and/or executed by the server computer 112). Although not separately illustrated in FIG. 4, operation 408 can correspond to the user device 102 detecting the selections (e.g., in operation 406) of the one or more provisioning options 130 presented in the user interfaces (e.g., in operation 404) and generating data (e.g., the provisioning selections 134) that represents the selected provisioning options. It should be understood that this example embodiment is illustrative, and therefore should not be construed as being limiting in any way.

From operation 408, the method 400 can proceed to operation 410. The method 400 can end at operation 410.

FIGS. 5A-5C are user interface (“UI”) diagrams showing aspects of UIs for using and/or interacting with the customer premises equipment management service 110 and/or the customer premises equipment management application 108, according to some illustrative embodiments. FIG. 5A shows an illustrative screen display 500A. According to some embodiments of the concepts and technologies described herein, the screen display 500A can be generated by a device such as the user device 102 via interactions with the customer premises equipment management service 110 and/or the customer premises equipment management application 108.

In particular, according to various embodiments, the user device 102 can generate the screen display 500A and/or other screen displays in conjunction with and/or based upon interactions with the customer premises equipment management service 110 described herein, which can be configured to send data that can be rendered by the customer premises equipment management application 108 to generate the screen display 500A using data provided by the customer premises equipment management service 110. It should be appreciated that the UI diagram illustrated in FIG. 5A is illustrative of one contemplated example of the UIs that can be generated and/or displayed in accordance with the concepts and technologies disclosed herein, and therefore should not be construed as being limiting in any way.

According to various embodiments, the screen display 500A can be presented, for example, during a setup process for the customer premises equipment 114 (e.g., installation and/or activation of the customer premises equipment 114 at the installation site 116), when the customer premises equipment is first powered-on, and/or at other times. Because the screen display 500A illustrated in FIG. 5A can be displayed at additional and/or alternative times, it should be understood that these examples are illustrative and therefore should not be construed as being limiting in any way.

The screen display 500A can include various menus and/or menu options (not shown in FIG. 5A). The screen display 500A also can include a customer premises equipment provisioning window 502. The customer premises equipment provisioning window 502 can be configured to enable a user or other entity to name the customer premises equipment 114 (e.g., via the device name field 504, which can be a text-editable field); enter login information such as a phone number or email address (e.g., via the login field 506, which can also be a text-editable field); create a password, encryption key, or the like (e.g., via a password field 508, which can also be a text-editable field); combinations thereof; or the like. As shown in FIG. 5A, a user or other entity has created a name of the customer premises equipment 114 via the device name field 504, a login (as a phone number) via the login field 506, and a password via the password field 508. It should be understood that this example embodiment is illustrative, and therefore should not be construed as being limiting in any way.

The customer premises equipment provisioning window 502 can also display and/or present various connections that are and/or are not available in a service selection area 510. As shown in FIG. 5A, the service selection area 510 can include an indication 512 that fiber-based connections are not available at the installation site 116, as well as some selectable options 514A-D (hereinafter collectively and/or generically referred to as “selectable options 514”) that can enable selection of one or more available connections at the installation site 116. It can be appreciated that the selectable options 514 can correspond to some or all of the provisioning options 130 illustrated and described herein. It should be understood that this example embodiment is illustrative, and therefore should not be construed as being limiting in any way.

Although in the example embodiment shown in FIG. 5A fiber-based Internet is not available at the installation site 116 and a user has selected selectable option 514B corresponding to a connection providing one hundred Megabits per second bandwidth, it should be understood that these examples are shown to illustrate the concepts and technologies disclosed herein. As such, it should be understood that this example embodiment is illustrative, and therefore should not be construed as being limiting in any way.

The customer premises equipment provisioning window 502 (and the service selection area 510 thereof) can further include a UI control 516 for presenting additional plans or options (e.g., other provisioning options 130 that are not shown in the service selection area 510). It can be appreciated that selection of the UI control 516 can cause the user device 102 to present additional selectable options 514 corresponding to additional provisioning options 130. It should be understood that this example embodiment is illustrative, and therefore should not be construed as being limiting in any way.

The customer premises equipment provisioning window 502 (and the service selection area 510 thereof) can further include a UI control 518 for enabling a temporary connection such as the temporary wireless connection 132 during provisioning of the requested connection 126. In the illustrated embodiment, this UI control 518 has not been selected (and the temporary wireless connection 132 has therefore not been requested). It should be understood that this example embodiment is illustrative, and therefore should not be construed as being limiting in any way.

The customer premises equipment provisioning window 502 also can include a UI control 520 to submit the provisioning selections 134 (e.g., the selected option selected via the selectable options 514 (if any) and the option to enable a temporary connection if selected via the UI control 518). Selection of the UI control 520 can cause the user device 102 to send the provisioning selections 134 to the server computer 112 (and the customer premises equipment management service 110 hosted and/or executed thereby). It should be understood that this example embodiment is illustrative, and therefore should not be construed as being limiting in any way. The customer premises equipment provisioning window 502 also can include a UI control 522 to cancel the provisioning of the customer premises equipment 114. Thus, for example, the user or other entity can select the UI control 522 to cause the user device 102 to close the customer premises equipment provisioning window 502 or to take other actions such as rechecking for available services or the like. Because additional or alternative controls can be included in the customer premises equipment provisioning window 502, it should be understood that the example embodiment shown in FIG. 5A is illustrative and therefore should not be construed as being limiting in any way.

FIG. 5B shows an illustrative screen display 500B. It can be appreciated that the screen display 500B shown in FIG. 5B can be substantially similar to the screen display 500A shown in FIG. 5A, but different selectable options 514 are shown. In particular, in FIG. 5B, the selectable option 514A can correspond to an option for a fiber-based connection (and therefore the indication 512 is not shown in FIG. 5B). It should be understood that this example embodiment is illustrative, and therefore should not be construed as being limiting in any way. According to various embodiments, the screen display 500B can be presented, for example, during the setup process for the customer premises equipment 114 (e.g., installation and/or activation of the customer premises equipment 114 at the installation site 116), when the customer premises equipment is first powered-on, and/or at other times such as when a user to other entity requests rechecking of available connections at the installation site 116 or elsewhere. Because the screen display 500B illustrated in FIG. 5B can be displayed at additional and/or alternative times, it should be understood that these examples are illustrative and therefore should not be construed as being limiting in any way.

As shown in FIG. 5B, a user or other entity has created a name of the customer premises equipment 114 via the device name field 504, a login (as a phone number) via the login field 506, and a password via the password field 508 (as shown in FIG. 5A), but the user or other entity has not selected one of the selectable options 514 corresponding to one of the available connections at the installation site 116. It should be understood that this example embodiment is illustrative, and therefore should not be construed as being limiting in any way. FIG. 5B also illustrates the user or other entity selecting the UI control 516 for presenting additional plans or options (e.g., other of the provisioning options 130 that are not shown in the service selection area 510). As noted above, selection of the UI control 516 can cause the user device 102 to present additional selectable options 514 corresponding to additional provisioning options 130, as will be shown in FIG. 5C. It should be understood that this example embodiment is illustrative, and therefore should not be construed as being limiting in any way.

FIG. 5C shows an illustrative screen display 500C. It can be appreciated that the screen display 500C shown in FIG. 5C can be substantially similar to the screen displays 500A, 500B shown in FIGS. 5A-5B, but different selectable options 514 (corresponding to different provisioning options) are shown in FIG. 5C. In particular, in FIG. 5C, the selectable option 514A can correspond to an option for a high-speed fiber-based connection (and therefore the indication 512 is not shown in FIG. 5C) that can provide bandwidth of up to five Gigabits per second. It should be understood that this example embodiment is illustrative, and therefore should not be construed as being limiting in any way.

According to various embodiments, the screen display 500C can be presented, for example, during the setup process for the customer premises equipment 114 (e.g., installation and/or activation of the customer premises equipment 114 at the installation site 116), when the customer premises equipment is first powered-on, and/or at other times such as when a user to other entity requests rechecking of available connections at the installation site 116 or elsewhere. Because the screen display 500C illustrated in FIG. 5C can be displayed at additional and/or alternative times, it should be understood that these examples are illustrative and therefore should not be construed as being limiting in any way.

As shown in FIG. 5C, a user or other entity has created a name of the customer premises equipment 114 via the device name field 504, a login (as a phone number) via the login field 506, and a password via the password field 508 (as shown in FIG. 5A). The user or other entity has also selected the selectable option 514A corresponding to the fiber-based connection, as well as the UI control 518 for enabling a temporary connection (e.g., the temporary wireless connection 132) as illustrated and described above. FIG. 5C also illustrates the user or other entity selecting the UI control 520 to submit the selections. As noted above, selection of the UI control 520 can cause the user device 102 to send the provisioning selections 134 to the server computer 112 (and the customer premises equipment management service 110 hosted and/or executed thereby). In the illustrated embodiment, the provisioning selections 134 can indicate that the requested connection 126 can correspond to a fiber-based connection and that the temporary wireless connection 132 is also requested. It should be understood that this example embodiment is illustrative, and therefore should not be construed as being limiting in any way.

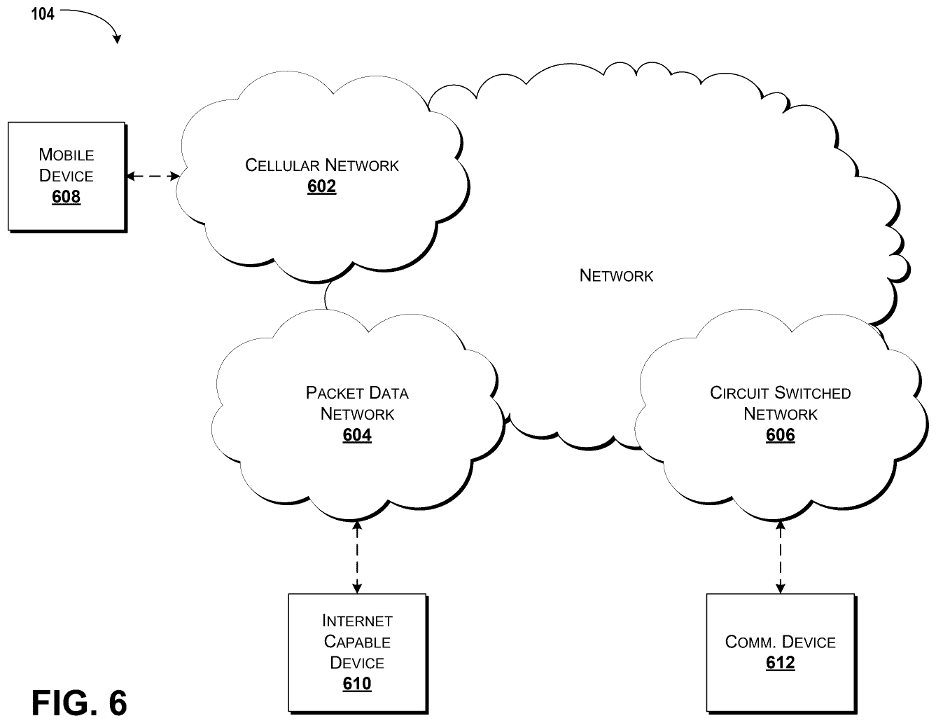

Turning now to FIG. 6, additional details of the network 104 are illustrated, according to an illustrative embodiment. The network 104 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 602 also can include various interfaces between various components, as is generally understood. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSUPA), and HSPA+. The cellular network 602 also is compatible with 4G mobile communications standards, 5G mobile communications standards, 6G mobile communication standards, other mobile communications standards, and evolved and future mobile communications standards.

The packet data network 604 includes various devices, for example, servers, computers, databases, and other devices in communication with one another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (POTS). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 104 is used to refer broadly to any combination of the networks 602, 604, 606. It should be appreciated that substantially all of the functionality described with reference to the network 104 can be performed by the cellular network 602, the packet data network 604, and/or the circuit switched network 606, alone or in combination with other networks, network elements, and the like.

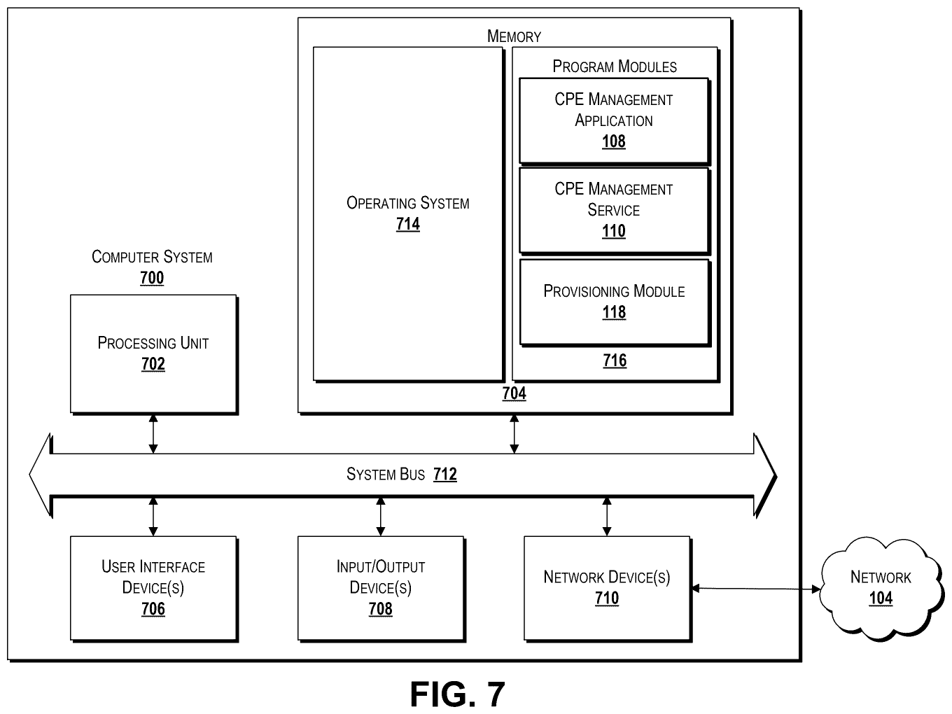

FIG. 7 is a block diagram illustrating a computer system 700 configured to provide the functionality described herein for providing edge-driven network provisioning, in accordance with various embodiments of the concepts and technologies disclosed herein. The computer system 700 includes a processing unit 702, a memory 704, one or more user interface devices 706, one or more input/output (“I/O”) devices 708, and one or more network devices 710, each of which is operatively connected to a system bus 712. The system bus 712 can enable bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. In some embodiments, for example, the program modules 716 can include the customer premises equipment management application 108, the customer premises equipment management service 110, and the provisioning module 118. These and/or other programs can be embodied in computer-readable media containing instructions that, when executed by the processing unit 702, perform one or more of the methods 200, 300, and 400 described in detail above with respect to FIGS. 2-4 and/or other functionality as illustrated and described herein. It can be appreciated that, at least by virtue of the instructions embodying the methods 200, 300, and 400, and/or other functionality illustrated and described herein being stored in the memory 704 and/or accessed and/or executed by the processing unit 702, the computer system 700 is a special-purpose computing system that can facilitate providing the functionality illustrated and described herein. According to embodiments, the program modules 716 may be embodied in hardware, software, firmware, or any combination thereof. Although not shown in FIG. 7, it should be understood that the memory 704 also can be configured to store the configuration request 124, the provisioning options 130, the provisioning selections 134, the provisioning commands 136, and/or other data, if desired.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer.

The network devices 710 enable the computer system 700 to communicate with other networks or remote systems via a network, such as the network 104. Examples of the network devices 710 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

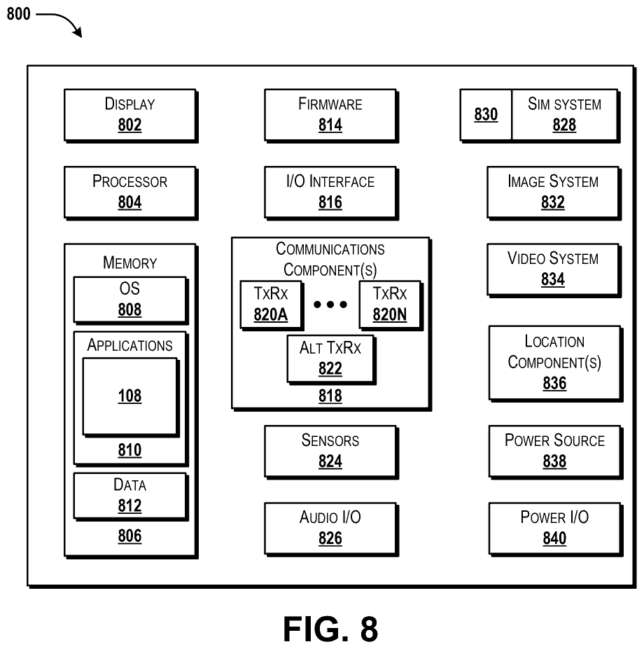

Turning now to FIG. 8, an illustrative mobile device 800 and components thereof will be described. In some embodiments, the user device 102 described above with reference to FIGS. 1-5C can be configured as and/or can have an architecture similar or identical to the mobile device 800 described herein in FIG. 8. It should be understood, however, that the user device 102 may or may not include the functionality described herein with reference to FIG. 8. While connections are not shown between the various components illustrated in FIG. 8, it should be understood that some, none, or all of the components illustrated in FIG. 8 can be configured to interact with one another to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various graphical user interface (“GUI”) elements such as, for example, available connections (e.g., the provisioning options 130), selections of the connections (e.g., provisioning selections 134), device names, login information, passwords, text, images, video, virtual keypads and/or keyboards, messaging data, notification messages, metadata, internet content, device status, time, date, calendar data, device preferences, map and location data, combinations thereof, and/or the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810 such as the customer premises equipment management application 108, the customer premises equipment management service 110, the provisioning module 118, other computer-executable instructions stored in a memory 806, or the like. In some embodiments, the applications 810 also can include a UI application (not illustrated in FIG. 8).

The UI application can interface with the operating system 808, such as the operating system 106 shown in FIG. 1, to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering content, creating device names, creating passwords, creating logins, selecting connections, requesting temporary connections, configuring settings, manipulating address book content and/or settings, multimode interaction, interacting with other applications 810, and otherwise facilitating user interaction with the operating system 808, the applications 810, and/or other types or instances of data 812 that can be stored at the mobile device 800. The data 812 can include, for example, customer premises equipment management application 108, the customer premises equipment management service 110, the provisioning module 118, and/or other applications or program modules. According to various embodiments, the data 812 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 810, the data 812, and/or portions thereof can be stored in the memory 806 and/or in a firmware 814, and can be executed by the processor 804.

It can be appreciated that, at least by virtue of storage of the instructions corresponding to the applications 810 and/or other instructions embodying other functionality illustrated and described herein in the memory 806, and/or by virtue of the instructions corresponding to the applications 810 and/or other instructions embodying other functionality illustrated and described herein being accessed and/or executed by the processor 804, the mobile device 800 is a special-purpose mobile device that can facilitate providing the functionality illustrated and described herein. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interface 816 can be configured to support the input/output of data such as location information, the configuration request 124, the provisioning options 130, the provisioning selections 134, the provisioning commands 136, user information, organization information, presence status information, user IDs, passwords, and application initiation (start-up) requests. In some embodiments, the I/O interface 816 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks such as the network 104 described herein. In some embodiments, other networks include networks that utilize non-cellular wireless technologies such as WI-FI or WIMAX. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments one or more of the transceivers of the communications component 818 may be configured to communicate using GSM, CDMAONE, CDMA2000, LTE, and various other 2G, 2.5G, 3G, 4G, 5G, 6G, and greater generation technology standards. Moreover, the communications component 818 may facilitate communications over various channel access methods (which may or may not be used by the aforementioned standards) including, but not limited to, TDMA, FDMA, W-CDMA, OFDM, SDMA, and the like.

In addition, the communications component 818 may facilitate data communications using GPRS, EDGE, the HSPA protocol family including HSDPA, EUL or otherwise termed HSUPA, HSPA+, and various other current and future wireless data access standards. In the illustrated embodiment, the communications component 818 can include a first transceiver (“TxRx”) 820A that can operate in a first communications mode (e.g., GSM). The communications component 818 also can include an N^{th} transceiver (“TxRx”) 820N that can operate in a second communications mode relative to the first transceiver 820A (e.g., UMTS). While two transceivers 820A-N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, orientation sensors, noise sensors, proximity sensors, or the like. As such, it should be understood that the sensors 824 can include, but are not limited to, accelerometers, magnetometers, gyroscopes, infrared sensors, noise sensors, microphones, combinations thereof, or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to an MMS message, email message, and sent to another mobile device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from global positioning system (“GPS”) devices, assisted-GPS (“A-GPS”) devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

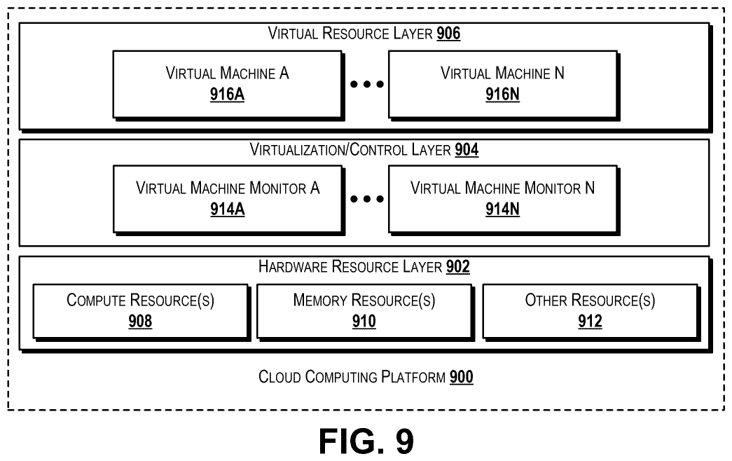

FIG. 9 illustrates an illustrative architecture for a cloud computing platform 900 that can be capable of executing the software components described herein for providing edge-driven network provisioning and/or for interacting with the customer premises equipment management application 108, the customer premises equipment management service 110, and/or the provisioning module 118. Thus, it can be appreciated that in some embodiments of the concepts and technologies disclosed herein, the cloud computing platform 900 illustrated in FIG. 9 can be used to provide the functionality described herein with respect to the user device 102, the server computer 112, the customer premises equipment 114, and/or the provider edge 128.

The cloud computing platform 900 thus may be utilized to execute any aspects of the software components presented herein. Thus, according to various embodiments of the concepts and technologies disclosed herein, the customer premises equipment management application 108, the customer premises equipment management service 110, and/or the provisioning module 118 can be implemented, at least in part, on or by elements included in the cloud computing platform 900 illustrated and described herein. Those skilled in the art will appreciate that the illustrated cloud computing platform 900 is a simplification of but only one possible implementation of an illustrative cloud computing platform, and as such, the illustrated cloud computing platform 900 should not be construed as being limiting in any way.

In the illustrated embodiment, the cloud computing platform 900 can include a hardware resource layer 902, a virtualization/control layer 904, and a virtual resource layer 906. These layers and/or other layers can be configured to cooperate with each other and/or other elements of a cloud computing platform 900 to perform operations as will be described in detail herein. While connections are shown between some of the components illustrated in FIG. 9, it should be understood that some, none, or all of the components illustrated in FIG. 9 can be configured to interact with one another to carry out various functions described herein. In some embodiments, the components are arranged so as to communicate via one or more networks such as, for example, the network 104 illustrated and described hereinabove (not shown in FIG. 9). Thus, it should be understood that FIG. 9 and the following description are intended to provide a general understanding of a suitable environment in which various aspects of embodiments can be implemented, and should not be construed as being limiting in any way.

The hardware resource layer 902 can provide hardware resources. In the illustrated embodiment, the hardware resources can include one or more compute resources 908, one or more memory resources 910, and one or more other resources 912. The compute resource(s) 908 can include one or more hardware components that can perform computations to process data, and/or to execute computer-executable instructions of one or more application programs, operating systems, services, and/or other software including, but not limited to, the customer premises equipment management application 108, the customer premises equipment management service 110, and/or the provisioning module 118 illustrated and described herein.

According to various embodiments, the compute resources 908 can include one or more central processing units (“CPUs”). The CPUs can be configured with one or more processing cores. In some embodiments, the compute resources 908 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 908 can include one or more discrete GPUs. In some other embodiments, the compute resources 908 can include one or more CPU and/or GPU components that can be configured in accordance with a co-processing CPU/GPU computing model. Thus, it can be appreciated that in some embodiments of the compute resources 908, a sequential part of an application can execute on a CPU and a computationally-intensive part of the application can be accelerated by the GPU. It should be understood that this example is illustrative, and therefore should not be construed as being limiting in any way.

In some embodiments, the compute resources 908 also can include one or more system on a chip (“SoC”) components. It should be understood that an SoC component can operate in association with one or more other components as illustrated and described herein, for example, one or more of the memory resources 910 and/or one or more of the other resources 912. In some embodiments in which an SoC component is included, the compute resources 908 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 908 can be or can include one or more hardware components arranged in accordance with an ARM architecture, available for license from ARM HOLDINGS of Cambridge, United Kingdom. Alternatively, the compute resources 908 can be or can include one or more hardware components arranged in accordance with an x86 architecture, such as an architecture available from INTEL CORPORATION of Mountain View, California, and others. Those skilled in the art will appreciate the implementation of the compute resources 908 can utilize various computation architectures and/or processing architectures. As such, the various example embodiments of the compute resources 908 as mentioned hereinabove should not be construed as being limiting in any way. Rather, implementations of embodiments of the concepts and technologies disclosed herein can be implemented using compute resources 908 having any of the particular computation architecture and/or combination of computation architectures mentioned herein as well as other architectures.

Although not separately illustrated in FIG. 9, it should be understood that the compute resources 908 illustrated and described herein can host and/or execute various services, applications, portals, and/or other functionality illustrated and described herein. Thus, the compute resources 908 can host and/or can execute the customer premises equipment management application 108, the customer premises equipment management service 110, and/or the provisioning module 118 or other applications or services illustrated and described herein.

The memory resource(s) 910 can include one or more hardware components that can perform or provide storage operations, including temporary and/or permanent storage operations. In some embodiments, the memory resource(s) 910 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 908, subject to the definition of “computer storage media” provided above (e.g., as excluding waves and signals per se and/or communication media as defined in this application).

Although not illustrated in FIG. 9, it should be understood that the memory resources 910 can host or store the various data illustrated and described herein including, but not limited to, the configuration request 124, the provisioning options 130, the provisioning selections 134, the provisioning commands 136, and/or other data, if desired. It should be understood that this example is illustrative, and therefore should not be construed as being limiting in any way.

The other resource(s) 912 can include any other hardware resources that can be utilized by the compute resources(s) 908 and/or the memory resource(s) 910 to perform operations. The other resource(s) 912 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 902 can be virtualized by one or more virtual machine monitors (“VMMs”) 914A-914N (also known as “hypervisors;” hereinafter “VMMs 914”). The VMMs 914 can operate within the virtualization/control layer 904 to manage one or more virtual resources that can reside in the virtual resource layer 906. The VMMs 914 can be or can include software, firmware, and/or hardware that alone or in combination with other software, firmware, and/or hardware, can manage one or more virtual resources operating within the virtual resource layer 906.

The virtual resources operating within the virtual resource layer 906 can include abstractions of at least a portion of the compute resources 908, the memory resources 910, the other resources 912, or any combination thereof. These abstractions are referred to herein as virtual machines (“VMs”). In the illustrated embodiment, the virtual resource layer 906 includes VMs 916A-916N (hereinafter “VMs 916”).

Based on the foregoing, it should be appreciated that systems and methods for providing edge-driven network provisioning have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving, from a customer premises equipment located at an installation site, a configuration request, wherein the configuration request identifies the customer premises equipment and a location associated with the installation site,
identifying available connections, the available connections comprising a plurality of data communication services that are available at the installation site for the customer premises equipment,
generating provisioning options that are based on the available connections,
identifying a user device associated with the customer premises equipment, wherein the user device is identified using information included in the configuration request,
providing, to the user device, the provisioning options, wherein the user device presents the provisioning options in a user interface presented at the user device,
receiving a provisioning selection comprising a selection of one of the provisioning options, and
sending a provisioning command comprising further computer-executable instructions to the customer premises equipment and a device on a network, wherein the provisioning command, when executed by the customer premises equipment and the device on the network, cause a service to be provisioned to the customer premises equipment, the service corresponding to the selection of the one of the provisioning options.

2. The system of claim 1, wherein identifying the available connections comprises determining the location associated with the customer premises equipment and determining the plurality of data communication services that are available at the installation site.

3. The system of claim 1, wherein the plurality of data communication services comprises a temporary wireless connection and a non-wireless connection.

4. The system of claim 1, wherein the customer premises equipment comprises first hardware for a fiber-based data connection and second hardware for a wireless data connection.

5. The system of claim 1, wherein the configuration request is received from the customer premises equipment via an out-of-band communication channel and a service provider application programming interface.

6. The system of claim 1, wherein identifying the user device comprises identifying, via identifying information included in the configuration request, the user device by querying a subscriber database.

7. The system of claim 1, wherein the device on the network comprises a provider edge, and wherein sending the provisioning command comprises sending the provisioning command to the customer premises equipment and the provider edge to cause the customer premises equipment and the provider edge to communicate via a requested connection.

8. A method comprising:
receiving, at a computer comprising a processor and from a customer premises equipment located at an installation site, a configuration request, wherein the configuration request identifies the customer premises equipment and a location associated with the installation site;
identifying, by the processor, available connections, the available connections comprising a plurality of data communication services that are available at the installation site for the customer premises equipment;
generating, by the processor, provisioning options that are based on the available connections;
identifying, by the processor, a user device associated with the customer premises equipment, wherein the user device is identified using information included in the configuration request;
providing, by the processor and to the user device, the provisioning options, wherein the user device presents the provisioning options in a user interface presented at the user device;
receiving, by the processor, a provisioning selection comprising a selection of one of the provisioning options; and
sending, by the processor, a provisioning command comprising computer-executable instructions to the customer premises equipment and a device on a network, wherein the provisioning command, when executed by the customer premises equipment and the device on the network, cause a service to be provisioned to the customer premises equipment, the service corresponding to the selection of the one of the provisioning options.

9. The method of claim 8, wherein identifying the available connections comprises determining the location associated with the customer premises equipment and determining the plurality of data communication services that are available at the installation site.

10. The method of claim 8, wherein the customer premises equipment comprises first hardware for a fiber-based data connection and second hardware for a wireless data connection.

11. The method of claim 8, wherein the configuration request is received from the customer premises equipment via an out-of-band communication channel and a service provider application programming interface.

12. The method of claim 8, wherein identifying the user device comprises identifying, via identifying information included in the configuration request, the user device by querying a subscriber database.

13. The method of claim 8, wherein the device on the network comprises a provider edge, and wherein sending the provisioning command comprises sending the provisioning command to the customer premises equipment and the provider edge to cause the customer premises equipment and the provider edge to communicate via a requested connection.

14. A computer storage medium having computer-executable instructions stored thereon that, when executed by a processor, cause the processor to perform operations comprising:
receiving, from a customer premises equipment located at an installation site, a configuration request, wherein the configuration request identifies the customer premises equipment and a location associated with the installation site;
identifying available connections, the available connections comprising a plurality of data communication services that are available at the installation site for the customer premises equipment;
generating provisioning options that are based on the available connections;
identifying a user device associated with the customer premises equipment, wherein the user device is identified using information included in the configuration request;
providing, to the user device, the provisioning options, wherein the user device presents the provisioning options in a user interface presented at the user device;
receiving a provisioning selection comprising a selection of one of the provisioning options; and
sending a provisioning command comprising further computer-executable instructions to the customer premises equipment and a device on a network, wherein the provisioning command, when executed by the customer premises equipment and the device on the network, cause a service to be provisioned to the customer premises equipment, the service corresponding to the selection of the one of the provisioning options.

15. The computer storage medium of claim 14, wherein identifying the available connections comprises determining the location associated with the customer premises equipment and determining the plurality of data communication services that are available at the installation site.

16. The computer storage medium of claim 14, wherein the plurality of data communication services comprises a temporary wireless connection and a non-wireless connection.

17. The computer storage medium of claim 14, wherein the customer premises equipment comprises first hardware for a fiber-based data connection and second hardware for a wireless data connection.

18. The computer storage medium of claim 14, wherein the configuration request is received from the customer premises equipment via an out-of-band communication channel and a service provider application programming interface.

19. The computer storage medium of claim 14, wherein identifying the user device comprises identifying, via identifying information included in the configuration request, the user device by querying a subscriber database.

20. The computer storage medium of claim 14, wherein the device on the network comprises a provider edge, and wherein sending the provisioning command comprises sending the provisioning command to the customer premises equipment and the provider edge to cause the customer premises equipment and the provider edge to communicate via a requested connection.
